(19) United States
(12) Patent Application Publication
(10) Pub. No.: US 2012/0301775 A1
(43) Pub. Date: Nov. 29, 2012

(54) ELECTRIC POWER CELL AND ELECTRIC ENERGY UNIT

(75) Inventors: Walter Lachenmeier, Sankt Augustin (DE); Andreas Gutsch, Luedinghausen (DE); Tim Schaefer, Harztor (DE); Claus-Rupert Hohenthanner, Hanau (DE)

(73) Assignee: Li-Tec Battery GmbH, Kamenz (DE)

(21) Appl. No.: 13/508,670

(22) PCT Filed: Nov. 9, 2010
(86) PCT No.: PCT/EP10/06824

§ 371 Date: Aug. 3, 2012

(30) Foreign Application Priority Data
Nov. 9, 2009 (DE) 10 2009 052 480.0

(51) Int. Cl. H01M 2/30; H01M 10/02

(52) U.S. Cl. 429/154; 429/179; 429/153

(57) ABSTRACT

A prismatic electric power cell has two flat current conductors, which project substantially perpendicular from one of the outer surfaces of the cell and which are arranged substantially plane-parallel to each other. The current conductors each have at least one hole in the direction of the surface normal thereof, wherein the hole pattern of one current conductor is mirror-symmetrical to the hole pattern of the other current conductor. The invention further relates to an electric power unit which has a plurality of the electric power cells.

The present invention relates to an electric power cell and an electric energy unit which consists of a plurality of electric power cells stacked together to form a block.

It is known to assemble electric energy units consisting of a plurality of electric power cells stacked together to form a block, such as batteries formed of galvanic primary cells, accumulators formed of galvanic secondary cells, stacked condensers and fuel cells that are combined into modules.

In particular, batteries (primary storage units) and accumulators (secondary storage units) for storing electric energy are known which are composed of one or more storage cells, in which when a charging current is applied, in an electrochemical charging reaction between a cathode and an anode in or between an electrolyte, electrical energy is converted into chemical energy and therefore stored, and in which when an electrical load is applied chemical energy is converted into electrical energy in an electrochemical discharge reaction. Primary storage units are generally only charged up once and must be disposed of after discharging, while secondary storage units allow multiple (from several 100 to more than 10,000) cycles of charging and discharging. It is to be noted in this context that accumulators are sometimes referred to as batteries, for example vehicle batteries, which as is well known undergo frequent charging cycles.

In recent years, primary and secondary storage units based on lithium compounds have been increasing in importance. These have a high energy density and thermal stability, supply a constant voltage for a small self-discharge and are free from the so-called memory effect.

It is known to produce energy storage units and in particular lithium batteries and accumulators in the form of thin sheets. On the functional principle of a lithium-ion cell a suitable reference can be made, for example, to the paper by Dr. K. C. Möller, Dr. M. Winter, “Primary and rechargeable lithium batteries and accumulators” presented at the Inorganic-chemical technology Workshop at TU Graz, February 2005.

In order to achieve the voltages and capacities demanded in practice, for example in automobile batteries, it is necessary to arrange a plurality of cells in a stack and to connect their current conductors together in a suitable manner. The interconnection of the individual cells typically takes place on a narrow (normally defined as “upper”) side of the cells, from which the current conductors project. WO 2008/128764 A1, WO 2008/128769 A1, WO 2008/128770 A1 and WO 2008/128771 A1 show examples of this type of interconnection arrangement.

JP 07-282841 A shows a similar arrangement, in which the individual cells are inserted into a housing. Here, the individual cells are loosely positioned in individual sections of a housing, and the upwardly protruding contacts are connected together by means of bolts. The whole arrangement is then sealed at the top with a lid.

From an as yet unpublished development it is known to combine multiple thin, parallelipipedal galvanic cells to form one or more stacks in such a manner that their sides of greatest extent (flat sides) are facing or touching each another, and are thus cast in a retaining device.

The inventors are also aware of an arrangement that is not documented in print in further detail, in which multiple flat cells are stacked between two pressure plates, wherein the stacks are held together by means of tension rods (threaded bolts or cylindrical screws) which extend between the pressure plates.

An object of the present invention is to create an electric power cell and an electric energy unit of a plurality of such cells, with which the block formation and contacting of the cells can be improved.

The object is achieved by means of the features of the independent claims. Advantageous extensions of the invention form the subject matter of the dependent claims.

According to a first aspect of the invention, an electric power cell is designed as a three-dimensional body having a plurality of outer surfaces and comprises two flat current conductors which project substantially perpendicular from one of the outer surfaces of the cell and which are arranged substantially plane-parallel to one another. The current conductors each have at least one hole in the direction of the surface normal thereof, wherein the hole pattern of the one current conductor is mirror-symmetrical to the hole pattern of the other current conductor.

In the context of the invention an electric power cell is to be understood to mean a constructionally closed cell, which is also capable of supplying electrical power. It can be a galvanic primary cell, which can supply the energy stored therein only once, or a galvanic secondary cell which can be charged and discharged multiple times, or a fuel cell or a condenser cell or similar. In particular, it can be a galvanic secondary cell, wherein at least one electromagnetically active material of the cell comprises lithium or a lithium compound. A current conductor in the context of the invention is to be understood as an externally accessible connection terminal which is connected to the electrochemically active parts inside the galvanic cell and which also serves as a pole of the cell.

An outer surface of a body in the context of the invention is to be understood to mean a surface which forms an external boundary of the three-dimensional content of the body. A flat body in the context of the invention is to be understood to mean a body whose extension in two spatial directions of a body-bound, Cartesian coordinate system is substantially greater than in the third spatial direction; in which case the third spatial direction is defined as a thickness direction or a surface normal direction, and the other two spatial directions as plane-parallel directions. A hole pattern in the context of the invention is understood to mean the arrangement of one or more holes in a body. By a mirror-symmetrical arrangement of the hole patterns it is to be understood in the context of the invention that the holes on a current conductor, on a plane defined by the directions of the surface normals of the current conductors and the outer surface of the cell from which the current conductors project, are mirror-inverted with respect to the holes of the other current conductor. The plane of reflection in this case is preferably the perpendicular plane, extending centrally in the width direction. It is not detrimental to the realisation of the invention however if the plane of reflection does not extend centrally in the width direction. By way of qualification it should be noted that the notion of mirror symmetry exclude congruence, that is, aligned arrangement of all holes in both current conductors, but not the aligned arrangement of some of the holes.

An electric power cell according to this aspect of the invention also has the advantage that, if a plurality of cells are combined in a block, the holes of the current conductors arranged one behind the other are always aligned, regardless of the pole direction of the individual cells. This means that e.g. a visual or mechanical alignment check can be carried out during the assembly, by means of the holes. Cables or the like can also be laid through the holes.

If the three-dimensional body of such an electric power cell has two flat sides and four narrow sides (i.e. it has a flat structure), wherein the outer surface from which the current conductors project is formed by one of the narrow sides, an arrangement of the cells in a stack in order to form a larger unit is particularly simple.

It proves to be advantageous if the current conductors are arranged offset in the direction of the surface normals, in particular near to the edge of the flat side of the cell, since they then reach the respective outermost layers of an active part of the cell without a large deflection.

If the current conductors are arranged offset in a plane-parallel direction, in particular such that there is a distance between the current conductors in the width direction, it is also ensured that the contour of a current conductor can never cover a hole in the other current conductor. Also, cables or the like can be laid in the channel [formed] by the inner edges of the current collectors.

Preferably a single hole is provided, which is preferably arranged in the width direction substantially in the centre of the respective current conductor. Alternatively, two or more holes are provided, which are distributed over the width of each current conductor.

In a further aspect the invention relates to an electric energy unit in which a majority of the electric power cells are stacked in a stacking direction to form a cell block, and inside the cell block are connected together in parallel and/or in series. In the context of the invention, an electric energy unit is to be understood to mean an arrangement which is also capable of supplying electrical energy. In such an electric energy unit the advantages of the individual electric power cells are manifested in the manner described above.

In a particularly preferred embodiment, the electrical contacting and insulation between opposite current conductors is produced according to the interconnection provided, by means of conducting or non-conducting spacers which are arranged in the gaps between current conductors of consecutive cells, wherein the spacers are clamped between the current conductors by a pressure force exerted by tension rods which extend through aligned holes in the current conductors. By this means, a simple, reliable, operationally safe and loss-proof interconnection of the cells in the cell block is also possible.

A first connection pole and a second connection pole of the electric energy unit are preferably provided, wherein the first connection pole is connected to a current conductor of a first polarity of the first cell in the cell block, and wherein the second connection pole is connected to a current conductor of a second polarity of the last cell in the cell block. A connection pole in the context of the invention is to be understood to mean a contact which can also be contacted from outside the electric energy unit, so that an electrical connection can be produced.

Preferably, the cells are arranged in the stacking direction with alternating polarity. In this manner it is particularly simple to implement a series circuit of the cells using the conducting and non-conducting spacers, by simply arranging these alternately between consecutive current conductors. Parallel circuits can also be easily implemented. Thus in an alternative embodiment, groups of cells can be formed inside the cell block and electrically isolated from one another by the fact that, from the last cell of a first group and the first cell of a following group the current conductors of one side are electrically insulated from the current conductors, each lying opposite in the stacking direction, of the previous cell and the next cell and are electrically tapped off.

Preferably, the cell block formed from the plurality of cells is clamped between two pressure plates, wherein the pressure plates are particularly preferably clamped by means of tension rods. In this manner the cells can be simply and reliably combined and fixed in place.

The connection between a current conductor and a connection pole can be produced particularly easily by means of the conducting spacer adjoining the respective current conductor.

In a particularly preferred embodiment, the spacers comprise through holes or incisions which are aligned with the holes of the current conductors, and are threaded or placed onto the rods. In the first variant the spacers are arranged in a particularly loss-proof manner; while in the second variant a simple mounting of the spacers is possible without completely disassembling the tension rods.

The additional features, objects and advantages of the present invention cited in the claims will become more clearly evident from the following description of preferred embodiments, which has been produced by reference to the accompanying drawings.

They show:

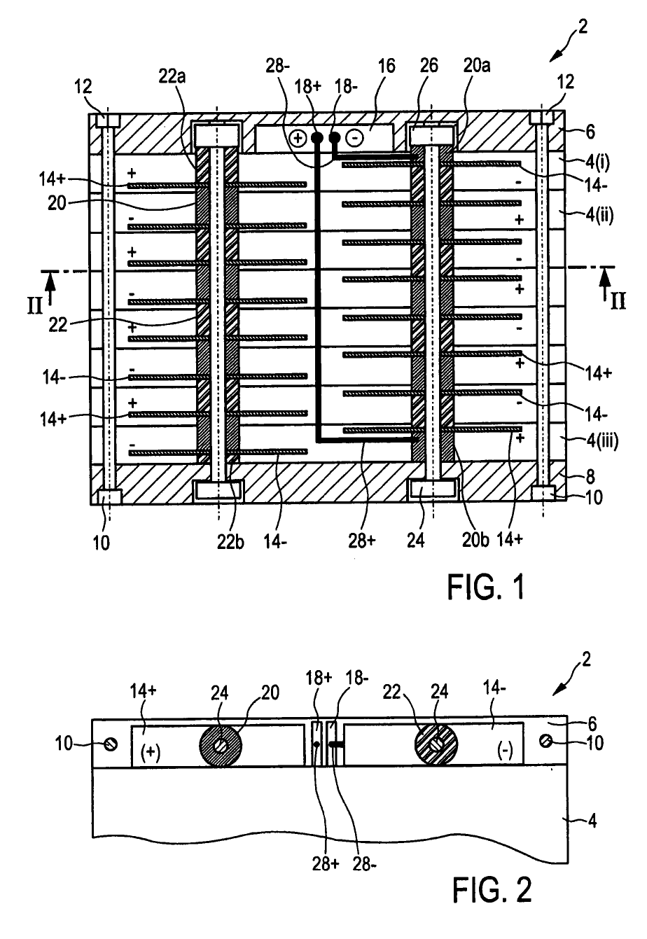

FIG. 1 a cut-away plan view of a battery according to a first embodiment of the invention;

FIG. 2 a cross-sectional view of the battery of FIG. 1, cut along a line II-II in FIG. 1, where a lower region has been broken away;

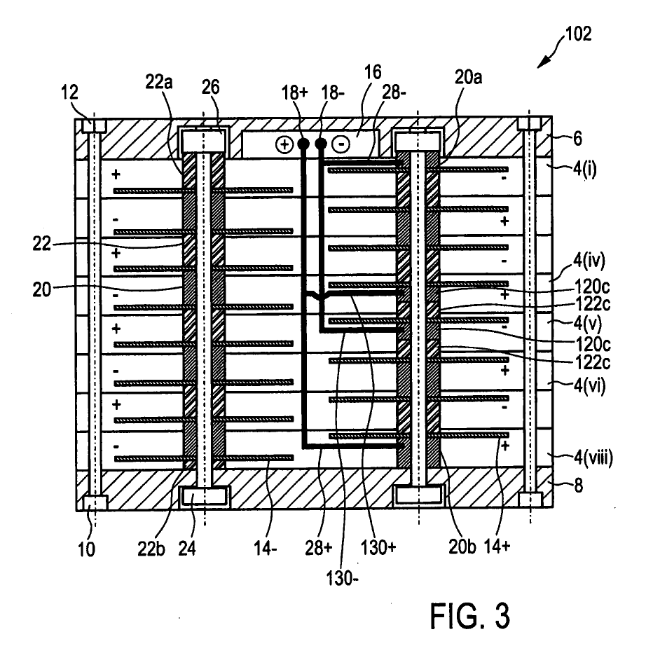

FIG. 3 a cut-away plan view of a battery according to a second embodiment of the invention, where the view corresponds to that in FIG. 1;

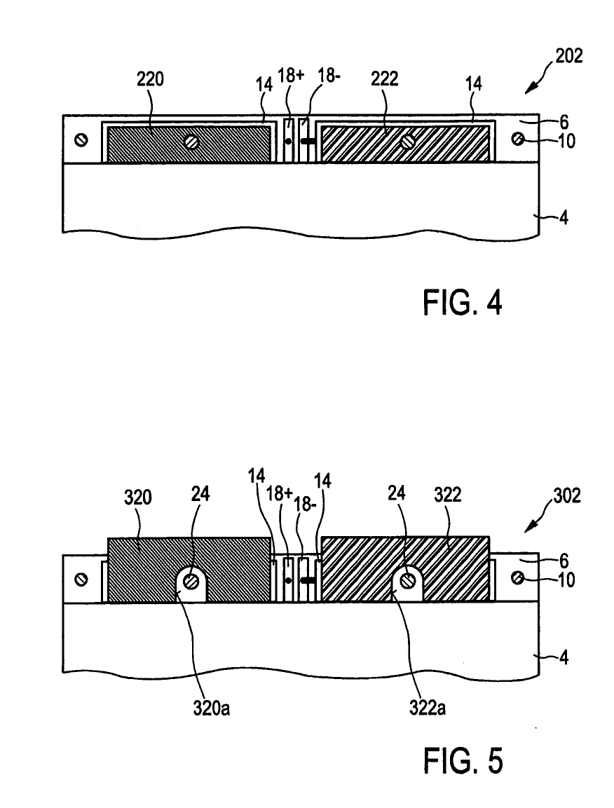

FIG. 4 a cross-sectional view of a battery according to a third embodiment of the invention, where the view corresponds to that in FIG. 2; and

FIG. 5 a cross-sectional view of a battery according to a fourth embodiment of the invention, where the view corresponds to that in FIG. 2.

It is pointed out that the representations in the Figures are schematic and restricted to the reproduction of the features most important for understanding the invention. It is also noted that the dimensions and proportions reproduced in the Figures and are solely chosen for clarity of illustration and are to be understood as in no way limiting or mandatory.

There now follows a precise description of specific embodiments and possible variations thereof. Where identical components are used in different embodiments, these are labelled with the same or corresponding reference marks. Repeated explanations of features already explained in connection with an embodiment are in general not given. Nevertheless, unless expressly stated otherwise or where it clearly makes no sense from a technical point of view, the features, arrangements and effects of an embodiment are also transferrable to other embodiments.

A first preferred embodiment of the present invention is illustrated in FIGS. 1 and 2. Of these, FIG. 1 is a cut-away plan view of a battery 2 in this embodiment, and FIG. 2 is a cross-sectional view of the battery 2 of FIG. 1, cut away along a line II-II in FIG. 1 (between two storage cells 4), where the lower region has been broken away. The section in FIG. 1 extends approximately at the centre level of current conductors 14.

The battery 2 comprises a plurality of storage cells 4. Altogether a total of eight storage cells 4(i) to 4(viii) are present. The storage cells 4 have a flat, parallelipipedal base with two extended flat sides or end faces (front and rear) and four narrow sides (right, left, top and bottom). The storage cells 4 each rest on one another with the flat front and rear sides thereof and form a stack. The whole stack is enclosed by a contact pressure plate 6 and a counter pressure plate 8. The pressure plates 6, 8 are held together by means of tension rods 10 with nuts 12. The block is clamped together in this manner.

The storage cells 4 in this preferred embodiment are lithium accumulator cells (in the context of this application accumulators, i.e. secondary storage units, are also referred to as batteries). The base of each storage cell 4 accommodates an active part, in which an electrochemical reaction for storing and supplying electrical energy takes place (charging and discharging reaction). The internal structure of the active part, not shown in detail in the Figure, corresponds to a flat, laminated stack of electrochemically active electrode foils of two types (cathode and anode), electrically conducting foils for collecting and supplying or conducting electrical current to or from the electrochemically active regions, and separator foils for separating the electrochemically active regions of the two types from each other. At least one of the types of electrochemically active electrode foils comprises lithium or a lithium compound. This structure is well-known in the art and need not be explained further here. The prior art according to Möller/Winter mentioned in the introduction to the description is cited as a reference, the disclosed content of which is thereby incorporated by reference in its entirety.

Two current conductors 14 (14+, 14−) project perpendicular to the narrow side of each cell 4 defined as the top, from the interior of the cell 4 to the outside. The current conductors 14 are connected to the electrochemically active cathode and anode regions inside the active region and thus serve as cathode and anode contacts of the cell 4.

In particular, the current conductor 14+ forms a plus pole of the cell 4 and the current conductor 14− a minus pole of the cell 4. The current conductors 14 are produced from a good conductor material, such as copper or aluminium. In order to improve the contacting, a coating (vapour deposition layer, plating or the like) of e.g. silver or gold can be provided. The current conductors 14 are flat structures, the width of which is somewhat less than half the width of the cell 4 and the height of which is markedly less than its width. They are arranged on the top of the cell 4, offset both in the width direction as well as in the thickness direction. In other words, relative to the centroid of the top of the cell 4, one of the current conductors 14 is displaced towards the long front edge and the right-hand narrow edge, and the other current conductor 14 is displaced towards the long rear edge and the left-hand narrow edge. The current conductors 14 do not overlap one another when viewed either from the end face or from the side, and their projections in each of these views are a distance apart. The arrangement of the current conductors is mirror-symmetric with respect to each axis of symmetry of the top of the cell 4.

The cells 4 are stacked with alternating polarity of the current conductors 14+, 14−. In other words, the first cell 4(i) is arranged in the cell block such that its positive current conductor 14+ is on the left-hand side of the drawing and its negative current conductor 14− on the right-hand side of the drawing. The next cell 4(ii) is arranged with reverse polarity, namely such that its positive current conductor 14+ is on the right-hand side of the drawing and its negative current conductor 14− on the left-hand side of the drawing. The polarities of the other cells 4 continue to alternate in each case, up to the last (eighth) cell 4(viii).

In the contact pressure plate 6, a pocket 16 is implemented. The pocket 16 is a recess, in which two connection terminals 18 (18+, 18−) are arranged. The connection terminals 18 are accessible from the outside and form the poles of the battery 2. In particular, the connection terminal 18+ forms a plus pole of the battery 2 and the connection terminal 18− a minus pole of the battery 2. In the pocket 16, space is provided for additional components (not shown in detail) for controlling and regulating the battery 2 and the individual cells 4.

The cells 4 of the present embodiment are connected together as a series circuit. For this purpose, a contact sleeve 20 is arranged in each gap between the positive current conductor 14+ of a cell 4 and the negative current conductor 14− of the next respective cell 4 in the sequence. In order to bridge across the spacing gap and to provide a counter-pressure, an insulating sleeve 22 is arranged in the gap between the negative current conductor 14− of a cell 4 and the positive current conductor 14+ of the next respective cell 4 in the sequence.

Tension rods 24 extend through the contact sleeves 20 and insulating sleeves 22 of each side and through holes (not labelled in further detail in the Figures) in the surface of the current conductors 14. These tension rods clamp the assembly of contact sleeves 20, insulating sleeves 22 and current conductors 14 together by means of locking nuts 26, and to the counter pressure plate 8. The locking nuts 26 for the tension rods 24 are rotationally fixed but axially displaceable, mounted in corresponding recesses of the contact pressure plate 6. The locking nuts 26 are preferably square nuts or hexagonal nuts.

For the purpose of length compensation, on the current conductors 14+, 14− of the first and last cell 4(i), 4(viii), on the side facing outwards in the stacking direction, end-contact sleeves 20a, 20b and end-insulating sleeves 22a, 22b are arranged which differ in length from the contact sleeves 20 and the insulating sleeves 22. These are arranged such that an end-contact sleeve 20a, 20b is provided at the point where an insulating sleeve 22 is arranged on the other side of the current conductor 14, and an end-insulating sleeve 22a, 22b is provided where a contact sleeve 20 is arranged on the other side of the current conductor 14.

More precisely, an end-contact sleeve 20a is provided between the negative current conductor 14− of the first cell 4(i) and the locking nut 26 on the right-hand side of the stack, while an insulating sleeve 22 is arranged between this negative current conductor 14− of the first cell 4(i) and the positive current conductor 14+ of the second cell 4(ii). In addition, an end-insulating sleeve 22a is provided between the positive current conductor 14+ of the first cell 4(i) and the locking nut 26 on the left-hand side of the stack, while a contact sleeve 20 is arranged between this positive current conductor 14+ of the first cell 4(i) and the negative current conductor 14− of the second cell 4(ii). Furthermore, an end-contact sleeve 20b is provided between the positive current conductor 14+ of the final cell 4(viii) and the counter pressure plate 8 on the right-hand side of the stack, while an insulating sleeve 22 is arranged between this positive current conductor 14+ of the final cell 4(viii) and the negative current conductor 14− of the penultimate cell 4(vii). Finally, an end-insulating sleeve 22b is provided between the negative current conductor 14− of the final cell 4(viii) and the counter pressure plate 8 on the left-hand side of the stack, while a contact sleeve 20 is arranged between this negative current conductor 14− of the final cell 4(viii) and the positive current conductor 14+ of the penultimate cell 4(vii). In this manner, on the side of the counter pressure plate 8, the clamping assembly is supported thereon in the axial direction. On the side of the contact pressure plate 6, no support is provided in the axial direction; in this case the force is applied directly by means of the locking nut 26.

The positive current conductor 14+ of the final cell 4(viii) is connected via a positive pole line 28+ to the positive connection terminal 18+, and the negative current conductor 14− of the first cell 4(i) is connected via a negative pole line 28− to the negative connection terminal 18−. The pole lines 28 (28+, 28−) are each fixed to the corresponding contact sleeve. The connection can also be made by means of a contact ring or similar, fixed to the respective pole line 28, which is threaded onto the tension rod 10 between the respective current conductor 14 and the corresponding contact sleeve and clamped together with these.

The contact sleeves 20, 20a, 20b are produced from a good conductor material. Suitable conductor materials are copper, brass, bronze or the like, but other materials are also conceivable, such as steel, aluminium, nickel silver or similar. To reduce the contact resistance between contacts, a silver-plating or gold-plating of the contact surface has proved beneficial. To further improve the reliability of the contact, the contact surfaces can be roughened.

The insulating sleeves 22, 22a, 22b are produced from an electrically insulating material. Suitable insulator materials are plastics, rubber, ceramic and the like. To prevent short-circuits, the tension rods 24 are also produced from an electrically insulating material, such as e.g. a plastic or similar, possibly fibre-reinforced. Alternatively, metallic tension rods can also be used, as long as an insulating coating is present that prevents any conducting contact with current-carrying parts, such as current conductors 14 or contact sleeves 20, 20, 20b. The pressure plates 6, 8 are preferably produced from a plastic. The tension rods 10 for producing the stack assembly of the cells 4 can be produced of metal or a plastic. The tension rods 10 and nuts 12 can also be melted to form a single tension rod, clinched at the ends; in this arrangement the releasing capability is lost, which can be desirable on safety grounds.

In the present embodiment the current conductors 14 have a hole (not labelled in further detail), for example in the centre of the surface thereof. It is also possible to displace the hole (and thereby the position of the tension rods 24) further outwards or inwards, or to provide a plurality of holes (and a plurality of rows of sleeves and tension rods on each side of the battery 2). Care must be taken, however, that the hole patterns of the two current conductors 14+, 14− of a cell 4 are mirror-symmetrical, so that with an alternating polarity in the cell stack the holes of consecutively placed current conductors 14 are aligned. (This ignores any notches or holes in the conductor which are used solely to identify the polarity of the conductor and have no function in the clamping assembly of the conductors 14, sleeves 20, 22, tension rods 24 and locking nuts 26.) It also advantageous if no hole in any of the current conductors is covered by the outline of the other respective current conductor. In particular, in their projection onto the end-face plane the current conductors should be placed a distance apart, so that the positive pole line 28+ can be guided between them. If the current conductors 14+, 14− of a cell 4 overlap each other from the direction of the end face, in addition to the holes for receiving the tension rods 24, further holes or breakthroughs can be provided in the current conductors 14, which are aligned with one another and through which the positive pole line 28− can be guided. The pole lines 28 can be insulated independently of this, in order to prevent short-circuits.

In the present embodiment a battery 2 has been formed by eight storage cells 4 connected in series. It is obvious that, on the basis of guidelines regarding battery voltage and capacity, the number of the cells 4 in the battery and their wiring can assume any reasonable configuration.

In FIG. 3 a battery 102 is illustrated as a second preferred embodiment of the present invention. The illustration corresponds to the plan view of FIG. 1 cut away at the level of the tension rods 10 and tension rods 24. The battery 102 differs from the battery 2 of the first embodiment only in the following aspects. In particular, the structure of the battery 102 with storage cells 4, pressure plates 6, 8, tension rods 10, nuts 12, current conductors 14 (14+, 14−) for each cell 4, connection terminals 18 (18+, 18−), (end-)contact sleeves 20, 20a, 20b, (end) insulating sleeves 22, 22a, 22b, tension rods 24, locking nuts 26, pole lines 28 (28+, 28−) etc. and the installation position of the cells 4 with alternating polarity, apart from the exception described below, is identical to the first embodiment.

In the battery 102 not all storage cells 4 are connected in series; rather a parallel circuit of two groups, each of four storage cells 4 is implemented. For this purpose the contact sleeve 20 of the first embodiment between the positive current conductor 14+ of the fourth cell 4(iv) and the negative current conductor 14− of the fifth cell 4(v) is replaced by an intermediate contact sleeve 120c and an intermediate insulating sleeve 122c, which in each case are approximately half as long as the distance between the current conductors 14+, 14−, wherein the intermediate contact sleeve 120c touches the positive current conductor 14+ of the fourth cell 4(iv). In the same way the insulating sleeve 22 of the first embodiment between the negative current conductor 14− of the fifth cell 4(v) and the positive current conductor 14+ of the sixth cell 4(vi) is replaced by an intermediate contact sleeve 120c and an intermediate insulating sleeve 122c, wherein the intermediate contact sleeve 120c touches the negative current conductor 14− of the fifth cell 4(v). A positive branch line 130+, which opens out into the positive pole line 28+, leads away from the intermediate contact sleeve 120c on the positive current conductor 14+ of the fourth cell 4(iv). A negative branch line 130−, which opens out into the negative pole line 28−, leads away from the intermediate contact sleeve 120c on the negative current conductor 14− of the fifth cell 4(v).

In this manner the first four storage cells 4(i) to 4(iv) of the battery 102 of this embodiment form a first series circuit, the terminal voltage of which is tapped off by the negative pole line 28− and the positive branch line 130+. In the same manner the last four storage cells 4(v) to 4(viii) of the battery 102 of this embodiment form a second series circuit, the terminal voltage of which is tapped off by the negative branch line 130− and the positive pole line 28+. The common potential tapped off by the positive pole line 28+ and the negative branch line 130+ is therefore present at the positive potential terminal 18+, and the common potential tapped off by the negative pole line 28− and the negative branch line 130− is present at the negative potential terminal 18−.

In comparison to the pure series circuit of the battery 2 of the first embodiment the battery 102 of the present embodiment provides half the terminal voltage and twice the capacity.

In the present embodiment the length of the intermediate contact sleeves 20c and the intermediate insulating sleeves 22c is in each case approximately half of the distance between the current conductors 14. In a variation of this embodiment the length of the intermediate insulating sleeves 22c can correspond almost to the distance between the current conductors 14, while the intermediate contact sleeves 20c are shortened into contact discs or contact rings.

In FIG. 4 a battery 202 is illustrated as a third preferred embodiment of the present invention. The illustration corresponds to the sectional view of FIG. 2. The battery 202 differs from the battery 2 of the first embodiment only in the following aspects. In particular, with regard to the structure of the battery 202, reference is made to the description and illustration of the battery 2 of the first embodiment having storage cells 4, pressure plates 6, 8, tension rods 10, nuts 12, current conductors 14 (14+, 14−) of each cell 4, connection terminals 18 (18+, 18−), tension rods 24, locking nuts 26, pole lines 28 (28+, 28−), and installation position of the cells 4 with alternating polarity.

In comparison to the first embodiment the contact sleeves 20 are replaced by contact shoes 220 of rectangular cross-section and the insulating sleeves 22 by insulating shoes 222 of rectangular cross-section. The cross-sectional area of the contact shoes 220 and the insulating shoes 222 is somewhat less than the area of the current conductors 14.

The same applies to the end-contact sleeves 20a, 20b and the end-insulating sleeves 22a, 22b and, if the variation of the second embodiment is applied, to the intermediate contact sleeves 20c and the intermediate insulating sleeves 22c.

This means that the pressure exerted by the tension rods 24 is more uniformly distributed, and the resistance of the contact elements 220 becomes smaller with the larger cross-section.

In FIG. 5 a battery 302 is illustrated as a fourth preferred embodiment of the present invention. The illustration corresponds to the sectional view of FIG. 2. The battery 302 differs from the battery 2 of the first embodiment only in the following aspects. In particular, with regard to the structure of the battery 302, reference is made to the description and illustration of the battery 2 of the first embodiment having storage cells 4, pressure plates 6, 8, tension rods 10, nuts 12, current conductors 14 (14+, 14−) of each cell 4, connection terminals 18 (18+, 18−), tension rods 24, locking nuts 26, pole lines 28 (28+, 28−), and installation position of the cells 4 with alternating polarity.

In comparison to the first embodiment the contact sleeves are replaced by contact bridges 320 of rectangular cross-section and the insulating sleeves 22 by insulating bridges 322 of rectangular cross-section. The width of the contact bridges 320 and the insulating bridges 322 is somewhat less than the width of the current conductors 14. The height of the contact bridges 320 and the insulating bridges 322 is larger than the height of the current conductors 14. The contact bridges 320 of the insulating bridges 322 have no hole, but have an incision 320a or 322a open at the bottom, which is wider than the tension rod 24 and extends further than the greatest distance of the tension rods 24 from the top side of the cell 4. The same applies to the end-contact sleeves 20a, 20b and the end-insulating sleeves 22a, 22b and, if the variation of the second embodiment is applied, to the intermediate contact sleeves 20c and the intermediate insulating sleeves 22c.

This means that the pressure exerted by the tension rods 24 can be more uniformly distributed, and the resistance of the contact elements 320 becomes smaller with the larger cross-section. In addition, the contact bridges 320, 322 are not threaded onto the tension rods 24. They can therefore be mounted, removed and replaced merely by loosening of the tension rods 24, without a complete disassembly of the tension rods 24 and re-threading of the current conductors and the contact and insulation elements being required.

The height of the contact and insulation bridges 320, 322 can turn out to be less than shown, such that for example there is not projection beyond the top edge of the pressure plate 6.

In the above described embodiments the storage cells 4 are installed in the battery block with alternating polarity. In a further variation it can be provided that the polarity of the cells does not change with every cell, but pairs or larger groups of consecutive cells 4 are installed, each with the same polarity. The pairs or groups can then each form parallel circuits, and consecutive pairs or groups can be connected in series. For this purpose, within a pair or a group, the current conductors of the same polarity, which are situated one behind another on the same side, can be electrically connected by means of contact elements (contact sleeves, contact shoes or contact bridges). At the transition from one pair or group to the next pair or to the next group, on one side a contact element is inserted and on the other side an insulation element. If a cell block of particularly high capacity is desired and the cell voltage of a single cell is not sufficient, then all cells in the block can also be arranged with the same polarity and the current conductors of each side can be connected together in each case by means of contact elements.

The tension rods 10 can extend at a different height to the tension rods 24. Although not shown in detail in the Figures, in the lower region of the batteries 2, 102, 202, 302 tension rods 10 can also be provided.

In the above, the invention has been described in terms of preferred embodiments and a number of variations thereof. It is obvious that the specific embodiments certainly illustrate and exemplify the claimed invention, but they do not limit it. The invention itself is defined and delimited solely by the most general interpretation of the claims. It is also obvious that the features of different embodiments and/or variations can be combined and/or exchanged in order to exploit the respective advantages.

A prismatic electric power cell comprises two flat current conductors, which project substantially perpendicular from one of the outer surfaces of the cell and which are arranged substantially plane-parallel to one another. The current conductors each have at least one hole in the direction of the surface normals thereof, wherein the hole pattern of the one current conductor is mirror-symmetrical to the hole pattern of the other current conductor. The invention also relates to an electric energy unit comprising a plurality of the electric power cells.

The storage cells 4 are electric power cells in the sense of the invention; and the batteries 2, 102, 202, 302 are electric energy units in the sense of the invention. The stack of cells 4 is a cell block in the sense of the invention. The connection terminals 18+, 18− are connection poles in the sense of the invention. Plus and minus are polarities in the sense of the invention. The contact sleeves 20, 20a, 20b, 20c, the contact shoes 220 and the contact bridges 320 are conducting spacers in the sense of the invention, and the insulating sleeves 22, 22a, 22b, 22c, the insulating shoes 222 and the insulating bridges 322 are insulating spacers in the sense of the invention.

### LIST OF REFERENCE LABELS

2 battery
4 storage cell
6 contact pressure plate
8 counter pressure plate
10 tension rod
12 nut
14+, 14− positive, negative conductor
16 terminal pocket
18+, 18− positive, negative connection terminal
20 contact sleeve
20a, 20b end-contact sleeve
22 insulating sleeve
22a, 22b end-insulating sleeve
24 tension rod
26 nut
28+, 28− positive, negative pole line
102 battery (2nd embodiment)
120c half-contact sleeve
122c half-insulating sleeve
130+, 130− positive, negative branch line
202 battery (3rd embodiment)
220 contact shoe
222 insulating shoe
302 battery (4th embodiment)
320 contact bridge (320a: incision)
322 insulating bridge (322a: incision)

It is expressly pointed out that the above list of reference labels forms an integral part of the description.

1. An electric power cell, which is designed as a three-dimensional body having a plurality of outer surfaces and which comprises two flat current conductors which project substantially perpendicular from one of the outer surfaces of the cell and which are arranged substantially plane-parallel to one another, wherein the current conductors each have a plurality of holes at least one hole in a direction of surface normals thereof, which are distributed over a width of each current conductor, and wherein a hole pattern of one current conductor is mirror-symmetrical to a hole pattern of the other current conductor.

2. The electric power cell according to claim 1, wherein the three-dimensional body has two flat sides and four narrow sides, wherein the one of the outer surfaces from which the current conductors project is formed by one of the narrow sides.

3. The electric power cell according to claim 1, wherein the current conductors are offset in the direction of the surface normals.

4. The electric power cell according to claim 1, wherein the current conductors are offset in a plane-parallel direction.

5-6. (canceled)

7. The electric power cell according to claim 1, wherein said cell is a galvanic cell, and an electromagnetically active material of the cell comprises lithium or a lithium compound.

8. An electric energy unit, having a plurality of cells which are stacked in a stacking direction to form a cell block and are connected together in parallel and/or in series inside the cell block, wherein the cells are electric power cells according to claim 1.

9. The electric energy unit according to claim 8, wherein the electrical contacting and insulation between opposing current conductors is produced according to the interconnection provided by conducting or non-conducting spacers which are arranged in gaps between current conductors of consecutive cells, and the spacers are clamped between the current conductors by a pressure force exerted by tension rods which extend through aligned holes in the current conductors.

10. The electric energy unit according to claim 8, wherein first connection pole and a second connection pole of the electric energy unit are provided, wherein the first connection pole is connected to a current conductor of a first polarity of the first cell in the cell block, and wherein the second connection pole is connected to a current conductor of a second polarity of the last cell in the cell block.

11. The electric energy unit according to claim 8, wherein the cells are arranged in the stacking direction with alternating polarity.

12. The electric energy unit according to claim 11, wherein groups of cells are formed inside the cell block and electrically isolated from one another by, from the last cell of a first group and the first cell of a following group the current conductors of one side are electrically insulated from the current conductors, each lying opposite in the stacking direction, of the previous cell and the next cell, and each being electrically tapped off.

13. The electric energy unit according to claim 8, wherein the cell block formed of the plurality of cells is clamped between two pressure plates.

14. The electric energy unit according to claim 8, wherein the connection between a current conductor and a connection pole is produced by the conducting spacer adjoining the respective current conductor.

15. The electric energy unit according to claim 8, wherein the spacers include through holes or incisions which are aligned with holes of the current conductors, and are threaded or placed onto rods.

16. The electric power cell according to claim 3, wherein the current conductors are offset in the direction of the surface normals near an edge of a flat side of the cell.

17. The electric power cell according to claim 4, wherein a separation exists between the current conductors in the width direction.

18. The electric power cell according to claim 7, wherein the cell is a secondary cell.

19. The electric energy unit according to claim 13, wherein the pressure plates are clamped by tension rods.
